(19) United States
(12) Patent Application Publication
(10) Pub. No.: US 2002/0140996 A1
(43) Pub. Date: Oct. 3, 2002

(54) Optical image scanner using pre-scan and post-scan compensation for illumination nonuniformity

(76) Inventors: Kurt E. Spears, Fort Collins, CO (US); Kip O. Morgan, Fort Collins, CO (US); Hans A. Lichtfuss, Court Loveland, CO (US)

Correspondence Address: HEWLETT-PACKARD COMPANY, Intellectual Property Administration, P. O. Box 272400, Fort Collins, CO, 80527-2400, US

(21) Appl. No.: 09/824,323

(22) Filed: Apr. 2, 2001

(51) Int. Cl. H04N 1/46

(52) U.S. Cl. 358/504; 358/509

(57) ABSTRACT

A scanner performs an initial calibration for lamp intensity before scanning, and a final calibration for lamp intensity after scanning. At least some compensation is performed after scanning is completed, using calibration values computed by interpolating between the initial calibration values and the final calibration values. As a result, the overall time is reduced substantially, because scanning can start without waiting for the lamp to stabilize. Linear interpolation may be used, or an additional calibration strip along the side of the image being scanned may provide calibration data for non-linear interpolation.

### FIELD OF INVENTION

This invention relates generally to image scanners and more specifically to compensation for changes in intensity and color during warm up of a lamp used for image scanning.

### BACKGROUND OF THE INVENTION

Image scanners, also known as document scanners, convert a visible image on a document or photograph, or an image in a transparent medium, into an electronic form suitable for copying, storing or processing by a computer. An image scanner may be a separate device, or an image scanner may be a part of a copier, part of a facsimile machine, or part of a multipurpose device. Reflective image scanners typically have a controlled source of light, and light is reflected off the surface of a document, through an optics system, and onto an array of photosensitive devices. Transparency image scanners pass light through a transparent image, for example a photographic positive slide, through an optics system, and then onto an array of photosensitive devices. The optics system focuses at least one line, called a scanline, on the image being scanned, onto the array of photosensitive devices. The photosensitive devices convert received light intensity into an electronic signal. An analog-to-digital converter converts the electronic signal into computer readable binary numbers, with each binary number representing an intensity value.

In some configurations, the light source is a long tube providing a narrow band of light which extends beyond each edge of the document for one dimension. For electric discharge lamps, such as cold-cathode fluorescent lamps, intensity and color is a function of power and temperature. The temperature of the vapor or gas, and the phosphors, indirectly affects intensity. Because of thermal time constants in the lamp, when such a lamp is first powered on, light intensity and color vary dynamically along the length of the tube until the overall temperature of the light source stabilizes.

The time required for complete stabilization may be on the order of many minutes. Image scanners using such a light source typically wait for some stabilization before scanning the document, typically for at least tens of seconds. In general, such a delay adds additional time to every scan. Computer input/output speeds have improved, and scanner performance has improved, to the extent that scanning time and computer input/output time may be less than lamp warm-up time. As scanning times have decreased, decreasing the delay due to lamp warm-up is becoming particularly important.

Lamp warm-up is important for color accuracy, in addition to intensity. The human eye contains three different kinds of color receptors (cones) that are sensitive to spectral bands that correspond roughly to red, green, and blue light. Specific sensitivities vary from person to person, but the average response for each receptor has been quantified and is known as the “CIE standard observer.” Accurate reproduction of color requires a light source that has adequate intensity in each of the spectral response ranges of the three types of receptors in the human eye. Typically, given a set of numerical values for photosensor responses for one pixel, for example, red, green, and blue, the numbers are mathematically treated as a vector. The vector is multiplied by a color transformation matrix to generate a different set of numbers. In general, the coefficients in the color transformation matrix compensate for differences between the response of photosensors and the response of the CIE standard observer, and the coefficients in the matrix may include compensation for the spectrum of the illumination source. See, for example, U.S. Pat. No. 5,793,884, and U.S. Pat. No. 5,753,906. An example output of the matrix is a set of coordinates in the CIE L*A*B* color space. Typically, matrix coefficients are fixed, and are obtained in a one-time factory calibration using a stable illumination source. With fixed matrix values, it is typically assumed that the spectrum of the illumination source is constant along the length of the lamp, and constant during the scan. Accordingly, it is common to wait for the lamp to stabilize before scanning to ensure that the spectrum of the illumination is close to the spectrum assumed in the matrix values.

There have been many approaches to accommodating lamp warm-up time or decreasing lamp warm-up time. Image scanners may simply wait open-loop for a worst case lamp warm-up time before initiating a scan. As one alternative to open-loop waiting, some image scanners leave the lamp on continuously. Fluorescent lamps for image scanners are relatively low power, so that continuous usage does not waste much power, but consumers may be concerned about the apparent waste of power and possible reduced lifetime.

In some scanners, the lamp is kept warm without being powered on continuously. For example, in some image scanners, the lamp is periodically turned on for a few minutes every hour during long periods of inactivity (see U.S. Pat. No. 5,153,745). In some scanners, the lamp is enclosed by a heating blanket (except for an aperture for light emission), which keeps the lamp continuously warm (see U.S. Pat. No. 5,029,311).

As another alternative, some image scanners overdrive the lamp initially to decrease the warm-up time (see U.S. Pat. No. 5,907,742; see also U.S. Pat. No. 5,914,871). In '742, the lamp current is also maintained at a low level between scans to keep the lamp warm.

Still another approach is to monitor a lamp parameter during warm-up, and delay scanning until the parameter is stable. For example, see U.S. Pat. No. 5,336,976, in which power to the lamp is monitored, and scanning is delayed until power stabilizes.

Even with a warm lamp, intensity varies along the length of the lamp. In particular, for a warm lamp, the center region of the lamp is typically brighter than the ends of the lamp. Reflective document scanners and copiers commonly have a transparent platen on which a document is placed for scanning. Reflective document scanners and copiers commonly provide a fixed-position calibration strip, along a scanline dimension, typically along one edge of the bottom surface of the platen. This calibration strip is used to compensate for variation in sensitivity of individual photosensors (photo-response non-uniformity or PRNU), and for variation in light intensity along the length of the scanline. See, for example, U.S. Pat. No. 5,285,293.

PRNU is a measure of the output of each photosensor compared to the expected voltage for a particular target calibration strip and illumination source. The calibration process compensates for at least four different factors: (1) non-uniform photosensor sensitivity, (2) non-uniform illumination, (3) cosine-fourth falloff of light at an angle relative to the optical axis of a lens, and (4) contamination in the optical path (for example, dust on a lens or other optical components). The first, third, and fourth factors are typically constant during a scan. The second factor may vary during a scan if lamp temperature has not stabilized. The primary concern of the present patent document is the variable second factor, but the PRNU calibration and compensation process includes calibration and compensation for the other factors as well.

FIG. 1 (prior art) illustrates an example of a system for performing PRNU compensation during scanning. FIG. 1 is not intended to literally represent any particular system, but instead is intended to illustrate the compensation functions being performed. In FIG. 1, a photosensor array 100 transfers charges to a charge shift register 102. Charges are serially shifted from the charge shift register 102 and converted to voltages. The resulting voltages pass through a summing junction 104 to an amplifier 106. A processor 110 has associated memory 108. Outputs from the amplifier 106 are converted by an analog-to-digital (A/D) converter 116 for reading by the processor 110. Digital outputs from the processor 110 are converted by digital-to-analog (D/A) converters 112 and 114. Before scanning, outputs from the photosensors 100 are measured, without exposure to light, to measure thermal noise (also called dark noise). The resulting digital dark noise values are stored in the memory 108. Also before scanning, the photosensors 100 are exposed to light from a calibration strip, and the resulting digital values are used to compute amplifier gain values that are stored in the memory 108. Essentially, the amplifier gain values ensure that, after compensation, the outputs of the amplifier are identical for all to photosensors when viewing the calibration strip. Then, during scanning, stored dark noise values are converted to voltages by D/A converter 112, and the resulting voltages are subtracted from corresponding image voltages at the summing junction 104. Stored amplifier gain values are converted to voltages by D/A converter 114, and the resulting voltages are used to control the gain of amplifier 106. The resulting image voltages, with noise offset and gain compensation, are converted by A/D converter 116 and are typically then sent to a host computer, or to some other destination for storing, printing, or transmitting.

If PRNU calibration is made while the intensity of the light source is still dynamically changing, an inaccurate sensor calibration may result. As a result, even though the intensity of the light source may be stable for most of the scan, the sensors will be inaccurate for the entire scan because of inaccurate initial calibration. Accordingly, it is common to wait for the lamp to stabilize before doing the PRNU calibration.

Even after the lamp is warm, there may be some intensity variation over time. Reflective document scanners and copiers also commonly provide a second calibration strip along one edge of the platen in the direction of scanning travel. This second calibration strip is used to compensate for variation in lamp intensity during a scan. Essentially, it is assumed that once the lamp is warm, then relative intensity variation along the length of the lamp is constant, so it is sufficient to measure intensity near one end of the lamp. See, for example, U.S. Pat. No. 5,278,674. It is also known to monitor the color of the lamp (again, just near one end), for gain compensation. For scanners having a moving carriage, with the lamp in the moving carriage, it is also known to provide a small tab on the moving carriage for intensity monitoring at one end of the lamp. See U.S. Pat. No. 6,028,681. Similarly, for a hand held scanner, it is known to provide small intensity calibration areas within the scanner, near the ends of the light source, and the entire scanner moves relative to a document being scanned. See U.S. Pat. No. 5,995,243.

In an earlier application from the same assignee, {HP docket number 10007856, filed Jan. 30, 2001}, one photosensor array is focused onto a scanline during scanning, and a separate photosensor array is used to monitor the lamp during scanning. With a separate photosensor array, scanning can begin without waiting for the lamp to warm up, and compensation values are updated during scanning. {HP docket number 10007856} also discloses scanning multiple scanlines for each sampling of the intensity and color of the lamp, and using interpolated lamp monitoring samples for compensation values.

There is an ongoing need to reduce the delay associated with lamp warm-up.

### SUMMARY OF THE INVENTION

A scanner performs an initial calibration for lamp intensity before scanning, and a final calibration for lamp intensity after scanning. At least some compensation is performed after scanning is completed, using calibration values computed by interpolating between the initial calibration values and the final calibration values. As a result, the overall time is reduced substantially, because scanning can start without waiting for the lamp to stabilize. Linear interpolation may be used, or an additional calibration strip along the side of the image being scanned may provide calibration data for non-linear interpolation. Optionally, lamp instability is reduced by continuous heating. Preferably, the effects of lamp instability are further reduced by completing each scan in a time that is less than the thermal time constants of concern in the lamp. That is, preferably, scanning is completed before the lamp intensity and lamp color change substantially. No additional photosensor arrays or other expensive parts are required.

### BRIEF DESCRIPTION OF THE DRAWINGS

FIG. 1 (prior art) is a block diagram of a system for gain compensation during scanning.

FIG. 2 is a cut away side view of an example of a scanner capable of compensation in accordance with the invention.

FIG. 3 is a plan view of the bottom of a platen illustrated in FIG. 2, showing two calibration strips illustrated in FIG. 2, and an optional third calibration strip.

### DETAILED DESCRIPTION OF THE PREFERRED EMBODIMENT OF THE INVENTION

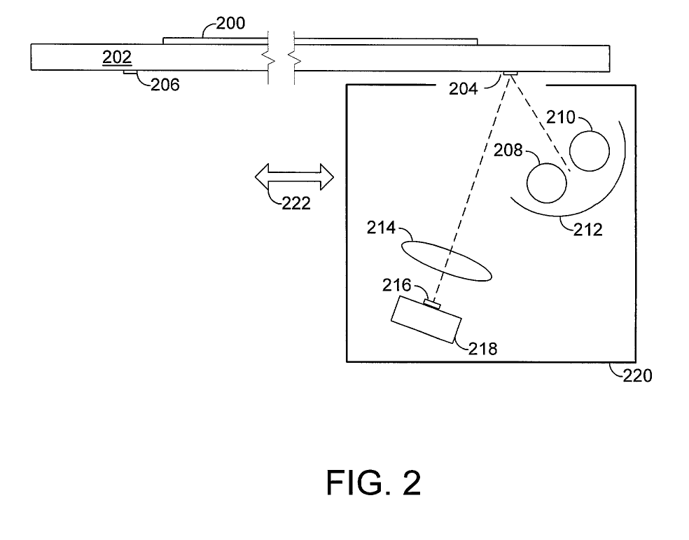

FIG. 2 illustrates an example of a scanner capable of compensation in accordance with the invention. In FIG. 2, a document 200 is placed face down onto a transparent platen 202. On the bottom side of the platen are two calibration strips, 204 and 206. A lamp assembly includes two lamps (208 and 210) and a reflector 212. Light from the lamp assembly, scattered from the calibration strip 204, is focused by a lens 214 onto photosensors 216 on a photosensor assembly 218. The lamps, lens, and photosensor assembly are contained within a carriage 220. The carriage 220 moves relative to the document 200, as depicted by arrow 222.

The configuration of FIG. 2 is merely an example and many variations are equally suitable for purposes of the invention. For example, the lamp assembly may contain one lamp or more than two lamps. Typically, for lens based scanners, the optical path in the carriage is folded by mirrors. The invention is equally applicable to scanners using contact imaging sensors. In general, it does not matter whether the optical assembly moves relative to a stationary document, or whether the document moves relative to a stationary optical assembly. As will be discussed further below, the second calibration strip 206 is preferable, but optional. The calibration strips are preferably gray or white, and should have a luminance factor that is uniform and known. The calibration strips may be painted onto the platen, or they may be attached, for example, adhesive backed paper strips. The invention is equally applicable to scanners for transparent images, as long as the photosensor sensitivity and lamp intensity can be calibrated before and after scanning.

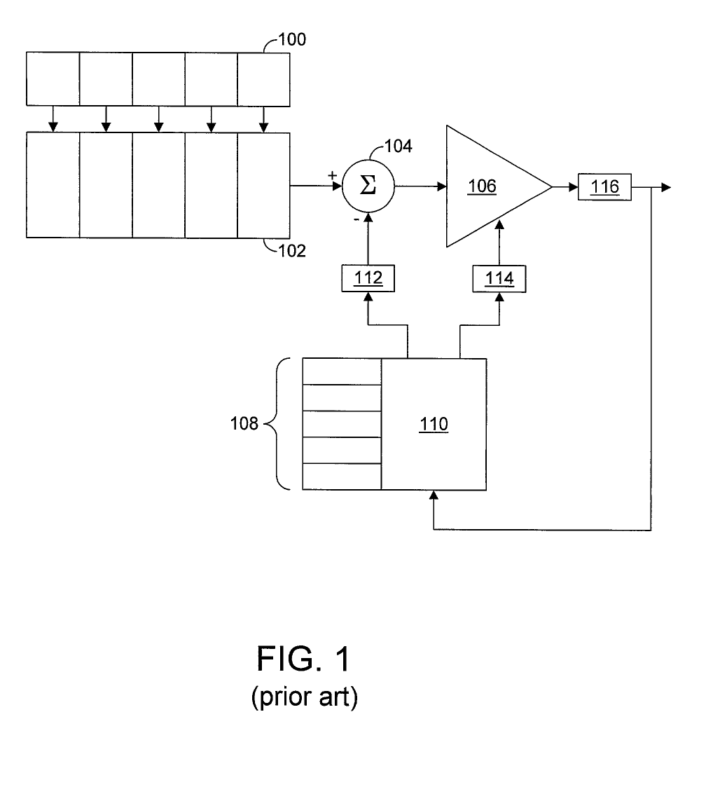

Before scanning, the scanner obtains initial PRNU calibration data from a calibration strip, for example, calibration strip 204. That is, with light scattered from the calibration strip focused onto the photosensor array, the resulting voltage from each imaging photosensor is measured. The initial calibration data may or may not be used for gain control during scanning as illustrated in FIG. 1. After scanning the document 100, final PRNU calibration data is obtained. For the final calibration data, the photosensor array may be focused onto a second calibration strip, (for example calibration strip 206 in FIG. 2), or the carriage may be moved back to the beginning position so that the photosensor array is again focused onto the calibration strip used for the initial calibration. Data obtained from the final calibration can be compared with the data from the initial calibration. If the two sets of calibration data are very similar, then either set of data or an average of the two sets of data can be used. If significant differences exist, then intermediate interpolated sets of calibration data can be calculated and used to modify the image data, as discussed in more detail below.

Photosensor array 216 may comprise a single row of photosensors, or multiple rows of photosensors. In particular, it is common to have one or more rows of photosensors receive one band of wavelengths (for example, red), another row or rows of photosensors receive a second band of wavelengths (for example, blue), and so forth. Preferably, each row or rows dedicated to a particular band of wavelengths is separately calibrated. Then, if the lamp color changes during scanning, the color change is compensated by the calibration and compensation process described below.

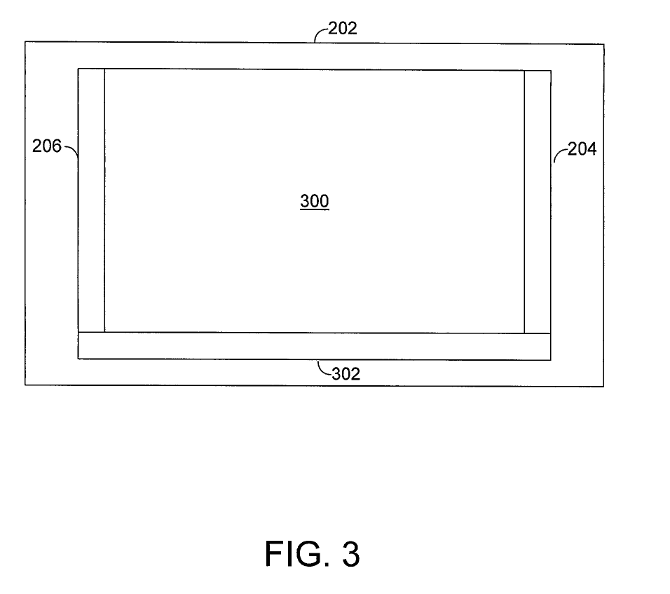

FIG. 3 illustrates the bottom of the platen 202, with calibration strips 204 and 206 at either end of a scan area 300. Also illustrated in FIG. 3 is an optional third calibration strip 302. As will be described in more detail below, the calibration strip 302 may be used to monitor light intensity from one end of the lamp during scanning. As will be described in more detail below, data from the third calibration strip may be used to compute non-linear interpolation. As an alternative to calibration strip 302, a small tab on the carriage (FIG. 2, 220) may be used to monitor light intensity from one end of the lamp during scanning, as taught in U.S. Pat. No. 6,028,681.

Assume that for photosensor N, for each color C, the measured voltage during initial PRNU calibration is V_{INITIAL}(N,C) and the expected voltage is V_{EXPECTED}. Assume that for photosensor N, for color C, the measured voltage during the final PRNU calibration is V_{FINAL}(N,C) and the expected voltage is again V_{EXPECTED}.

The initial PRNU gain adjustment for photosensor N, for color C, is as follows:

G_{INITIAL}(N,C)=V_{EXPECTED}/V_{INITIAL}(N,C)

The final PRNU gain adjustment, for photosensor N, for color C, is as follows:

G_{FINAL}(N,C)=V_{EXPECTED}/V_{FINAL}(N,C)

There are multiple alternatives for interpolation. For a first alternative, assume that scanning is continuous (no start-stop), and that the third calibration strip 302 is not used. Assume that for each color there are Y total scanlines in the scan area. Linear interpolation may be based on the scanline number. The PRNU gain adjustment, for photosensor N, for each color C, for scanline y, is as follows:

G(N,C,y)=G_{INITIAL}(N,C)+(y/Y)*[G_{FINAL}(N,C)−G_{INITIAL}(N,C)]

If some pauses occur in scanning, for example, if a host computer buffer fills, requiring the scanner to pause, then linear interpolation may be made based on time instead of scanline number. Assume that the initial PRNU calibration occurs at time T_{INITIAL}, that the final PRNU calibration occurs at time T_{FINAL}, and data for photosensor N, for color C, in scanline y is obtained at time T(N,C,y). The PRNU gain adjustment, for photosensor N, for each color, for scanline y, is as follows:

G(N,C,y)=G_{INITIAL}(N,C)+[(T(N,C,y)−T_{INITIAL})/(T_{FINAL}−T_{INITIAL})]*[G_{FINAL}(N,C)−G_{INITIAL}(N,C)]

Finally, a third calibration strip (FIG. 3, 302), or a small tab on the carriage, may be used to aid interpolation. In particular, a third calibration strip or tab may be used to enable non-linear interpolation during post-scan numerical processing. Assume that multiple photosensors monitor the intensity of the third calibration strip 302. For scanline y, the PRNU of each of the photosensors monitoring calibration strip 302 is calibrated. That is, for every scanline, for each photosensor monitoring calibration strip 302, given an actual voltage output of V_{ACTUAL}(N,C), a gain is computed as V_{EXPECTED}/V_{ACTUAL}(N,C). The average gain for all the photosensors monitoring calibration strip 302, for color C, for the initial PRNU calibration is G_{INITIALAVERAGE}(C). The average gain for all the photosensors monitoring calibration strip 302, for color C, for the final PRNU calibration is G_{FINALAVERAGE}(C). For scanline y, the average gain for all the photosensors monitoring calibration strip 302, for color C, is G_{AVERAGE}(y,C). The PRNU gain adjustment for photosensor N, for color C, for scanline y, is as follows:

G(N,C,y)=G_{INITIAL}(N,C)+[(G_{AVERAGE}(y,C))/(G_{FINALAVERAGE}(C)−G_{INITIALAVERAGE}(C))]*[G_{FINAL}(N,C)−G_{INITIAL}(N,C)]

The entire gain adjustment in the above equations may be implemented by post-scan numerical processing. Alternatively, the initial calibrated gain (G_{INITIAL}(N,C)) can be used in real time while scanning, as in FIG. 1, and then the remaining portion of each equation can be implemented by post-scan numerical processing (notice in each of the above examples that the first term is G_{INITIAL}(N,C)). Using the initial calibrated gain in real time is preferable because signal-to-noise is improved when the dynamic range of the output of each photosensor is matched to the dynamic range of the associated analog-to-digital converter.

By using post-scan PRNU calibration, scanning can start without having to wait for the lamp temperature to stabilize. However, it is still preferable to minimize any lamp instability. Optionally, lamp instability can be reduced by continuous heating. One possibility is to maintain a low current through the lamp between scans, as discussed in U.S. Pat. No. 5,907,742. Another possibility is use of an external heater. For example, there are commercially available cold cathode fluorescent lamps that have a nichrome wire wrapped around the exterior of the lamp. Such bulbs are available, for example, from Stanley Iwaki Works Co., Ltd., 50 Hamaiba, Shiramizu-Machi, Uchigo, Iwaki-Shi, Fukushima-Ken, 973 Japan. Passing a current through the nichrome wire heats the tube wall. A reflector, for example, FIG. 1, 212, or diffuser, diffuses light sufficiently to provide uniform illumination along a scanline even if part of the surface of the lamp is obscured by a wire.

Preferably, the effects of lamp instability are further reduced by completing each scan in a time that is less than the thermal time constants of concern in the lamp. That is, preferably, scanning is completed before the lamp intensity and lamp color change substantially. In particular, with proposed high speed personal computer interfaces, it will be possible to scan an image and transfer the data into a host computer in about five seconds.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of scanning, comprising:
calibrating an initial gain for data from a photosensor, before scanning;
obtaining image data from the photosensor;
calibrating a final gain for the photosensor, after obtaining the image data; and
using the initial gain and the final gain to modify the image data from the photosensor.

2. The method of scanning as in claim 1, the step of calibrating an initial gain further comprising:
scanning a first calibration strip.

3. The method of scanning as in claim 2, the step of calibrating a final gain further comprising:
scanning a second calibration strip.

4. The method of scanning as in claim 3, the photosensor being a first photosensor, the method further comprising:
scanning a third calibration strip, with a second photosensor, during the step of obtaining image data;
calibrating a gain for the second photosensor; and
using the gain for the second photosensor, and the initial gain, and the final gain, to modify the image data from the first photosensor.

5. The method of scanning as in claim 3, the photosensor being a first photosensor, the method further comprising:
scanning a portion of a moving carriage, with a second photosensor, during the step of obtaining image data;
calibrating a gain for the second photosensor; and
using the gain for the second photosensor, and the initial gain, and the final gain, to modify the image data from the first photosensor.

6. The method of scanning as in claim 2, the step of calibrating a final gain further comprising:
scanning the first calibration strip a second time.

7. An apparatus for image scanning, comprising:
a platen for receiving an image to be scanned, the platen having a first end, and a second end opposite the first end, wherein a direction of scanning is from the first end to the second end;
a first calibration strip, near the first end; and
a second calibration strip, near the second end.

8. The apparatus of claim 7, further comprising:
a third calibration strip, along a side connecting the first end to the second end.

9. The apparatus of claim 7, further comprising:
a calibration tab on a carriage.

10. The apparatus of claim 7, further comprising:
a lamp for illuminating the image to be scanned, the lamp having an external heating system that keeps the lamp warm when the lamp is not illuminated.
